(19) United States
(12) Patent Application Publication
(10) Pub. No.: US 2025/0289004 A1
(43) Pub. Date: Sep. 18, 2025

(54) MAGNETIC BASED SEPARATION OF RARE EARTH METALS USING MAGNETIC FIELDS

(71) Applicants: Florida State University Research Foundation, Inc., Tallahassee, FL (US); FLORIDA A&M UNIVERSITY, Tallahassee, FL (US)

(72) Inventors: Hadi Mohammadigoushki, Tallahassee, FL (US); Theo M. Siegrist, Tallahassee, FL (US); Jamel Ali, Tallahassee, FL (US); Munir Humayun, Tallahassee, FL (US); Prateek Benhal, Tallahassee, FL (US)

(21) Appl. No.: 19/079,061

(22) Filed: Mar. 13, 2025

Related U.S. Application Data
(60) Provisional application No. 63/565,095, filed on Mar. 14, 2024.

(51) Int. Cl. B03C 1/034; C22B 59/00

(52) U.S. Cl. CPC B03C 1/034; C22B 59/00; B03C 2201/18; B03C 2201/22

(57) ABSTRACT

Systems and methods are provided for magnetically assisted separation of metal ions, such as rare-earth metal ions (e.g., dysprosium (Dy) and yttrium (Y)). A batch (or closed) process or a flow through process can be used to separate first metal ions from second metal ions in a magnetic field. The batch process can use a non-uniform magnetic field, and the flow through process can use a uniform magnetic field.

### CROSS-REFERENCE TO RELATED APPLICATION

This application claims the benefit of U.S. Provisional Application Ser. No. 63/565,095, filed Mar. 14, 2024, the disclosure of which is hereby incorporated by reference in its entirety, including all figures, tables, and drawings.

### BACKGROUND

Existing separation techniques for magnetic particles focus on separating microparticles that are superparamagnetic (e.g., iron oxide). However, the existing techniques cannot be used for capturing rare-earth metal ions, which are smaller than nanoparticles and much less magnetic than superparamagnetic particles.

### BRIEF SUMMARY

Embodiments of the subject invention provide novel and advantageous systems and methods for magnetically assisted separation of rare-earth metal ions (e.g., dysprosium (Dy) and yttrium (Y)). A batch (or closed) process or a flow through process can be used to separate first rare-earth metal ions (e.g., Dy⁺³) from second rare-earth metal ions (e.g., Y⁺³) in a magnetic field. The batch process can use a non-uniform magnetic field, and the flow through process can use a uniform magnetic field.

In an embodiment, a method for magnetically assisted separation of metal ions can comprise: generating a uniform magnetic field with a magnetic field source; placing a solution in the uniform magnetic field, wherein the solution comprises first metal ions and second metal ions different from the first metal ions; placing a mesh (e.g., a magnetic or ferromagnetic mesh) in or adjacent to the solution; and allowing at least a portion of the first metal ions to be collected by the mesh while the second metal ions are not collected by the mesh. The first metal ions and/or the second metal ions can be rare-earth metal ions (e.g., Dy and Y, respectively, such as Dy⁺³ and Y⁺³). The first metal ions can be paramagnetic, and/or the second metal ions can be diamagnetic. The mesh can be steel, such as stainless steel with ferromagnetic properties (i.e., magnetic stainless steel (or ferromagnetic stainless steel)). The solution can be provided in the uniform magnetic field continuously for a period of time (e.g., at least one minute, at least two hours, at least four hours, or at least 16 hours). The uniform magnetic field can have a value in a range of, for example, from 0.1 Tesla (T) to 20 T (e.g., about 1 T). The magnetic field source can be, for example, an electromagnet. The solution can comprise compounds having the first and second metal ions, such as chloride compounds.

In another embodiment, a system for magnetically assisted separation of metal ions can comprise: a magnetic field source generating a uniform magnetic field; and a mesh (e.g., a magnetic or ferromagnetic mesh) disposed within or adjacent to the uniform magnetic field. The can be configured to receive within the uniform magnetic field a solution comprising first metal ions and second metal ions different from the first metal ions and allow at least a portion of the first metal ions to be collected by the mesh while the second metal ions are not collected by the mesh. The system can comprise any, all, or any combination of features discussed in the previous paragraph.

In another embodiment, a method for magnetically assisted separation of metal ions can comprise: generating a non-uniform magnetic field with a magnetic field source; providing to the non-uniform magnetic field a porous medium comprising first metal ions and second metal ions different from the first metal ions; and allowing at least a portion of the first metal ions to move through the porous medium towards the magnetic field source while at least a portion of the second metal ions move through the porous medium away from the magnetic field source. The first metal ions and/or the second metal ions can be rare-earth metal ions (e.g., Dy and Y, respectively). The first metal ions can be paramagnetic, and/or the second metal ions can be diamagnetic. The first metal ions and the second metal ions can be provided in a solution. The solution can comprise compounds having the first and second metal ions, such as chloride compounds. The non-uniform magnetic field can have a value of magnetic field times gradient of the magnetic field (i.e., B*(gradient(B))) in a range of, for example, from 1 square Tesla per meter (T²/m) to 20 T²/m (e.g., about 7 T²/m). The first metal ions can have a concentration enhancement (after performing the batch separation process) of at least 10%. The second metal ions can have a concentration enhancement (after performing the batch separation process) of at least 10%. The method can be a batch process performed for a period of time (e.g., in a range of from 1 hour to 10 days, or from about 1 day to about 2 days, such as about 2 days). The magnetic field source can be, for example, an electromagnet.

In another embodiment, a system for magnetically assisted separation of metal ions can comprise: a magnetic field source generating a non-uniform magnetic field; and a porous medium disposed within the non-uniform magnetic field. The system can be configured to receive within the non-uniform magnetic field a first metal ions and second metal ions different from the first metal ions and allow at least a portion of the first metal ions to move through the porous medium towards the magnetic field source while at least a portion of the second metal ions move through the porous medium away from the magnetic field source. The system can comprise any, all, or any combination of features discussed in the previous paragraph.

### BRIEF DESCRIPTION OF DRAWINGS

FIG. 1 shows a diagram of batch separation, according to an embodiment of the subject invention.

FIG. 2 shows an image of flow separation, according to an embodiment of the subject invention.

FIG. 3 shows a plot of concentration (in molar (M)) versus time (in days), showing results for batch separation of dysprosium (Dy⁺³) chloride (DyCl₃). The (red) diamond data points are for “Near”; the (green) triangle data points are for “Far”; and the white square data points are for “Control”.

FIG. 4 shows a plot of concentration (in M) versus time (in days), showing results for batch separation of yttrium (Y⁺³) chloride (YCl₃). The (red) diamond data points are for “Near”; the (green) triangle data points are for “Far”; and the white square data points are for “Control”.

FIG. 5 show a plot of percentage capture (in %) versus time, showing capture of DyCl₃ in flow separation. As indicated in FIG. 5, there was zero capture for YCl₃.

### DETAILED DESCRIPTION

Embodiments of the subject invention provide novel and advantageous systems and methods for magnetically assisted separation of rare-earth metal ions (e.g., dysprosium (Dy) and yttrium (Y)). A batch (or closed) process or a flow through process can be used to separate first rare-earth metal ions (e.g., Dy⁺³) from second rare-earth metal ions (e.g., Y⁺³) in a magnetic field. The batch process can use a non-uniform magnetic field, and the flow through process can use a uniform magnetic field.

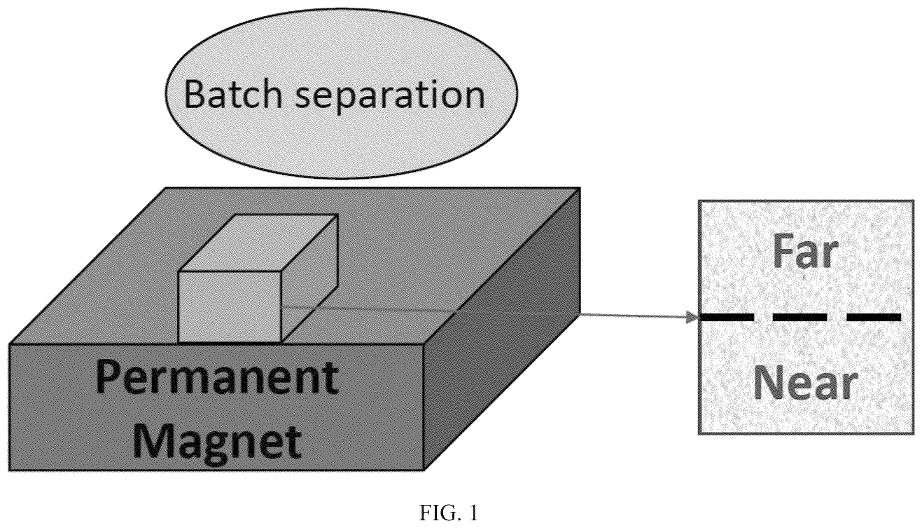

FIG. 1 shows a diagram of batch separation, according to an embodiment of the subject invention. Referring to FIG. 1, in the batch process, rare-earth metal ions can move in a porous medium and a non-uniform magnetic field can be imposed (e.g., by a permanent magnet). The ions can be in a solution. First ions (e.g., Dy⁺³) can move toward the magnetic field source (e.g., permanent magnet), where a larger magnetic field gradient is imposed, while second ions (e.g., diamagnetic ions, such as Y⁺³) different from the first ions can move away from the magnetic source. This results in a concentration enhancement of the first ions towards the magnetic field and a concentration enhancement of the second ions away from the magnetic field. The concentration enhancement of each of the first ions and the second ions can be, for example, at least 10% or in a range of from 10% to 100% (or any subrange, any value, or about any value therein), though embodiments are not limited thereto. The non-uniform magnetic field can have a value of magnetic field times gradient of the magnetic field (i.e., B*(gradient(B))) in a range of, for example, from 1 square Tesla per meter (T²/m) to 20 T²/m (or any subrange, any value, or about any value therein, such as about 7 T²/m), though embodiments are not limited thereto. The batch separation process can be performed for an amount of time in a range of, for example, from 1 hour to 10 days (or any subrange, any value, or about any value therein, such as about 2 days), though embodiments are not limited thereto.

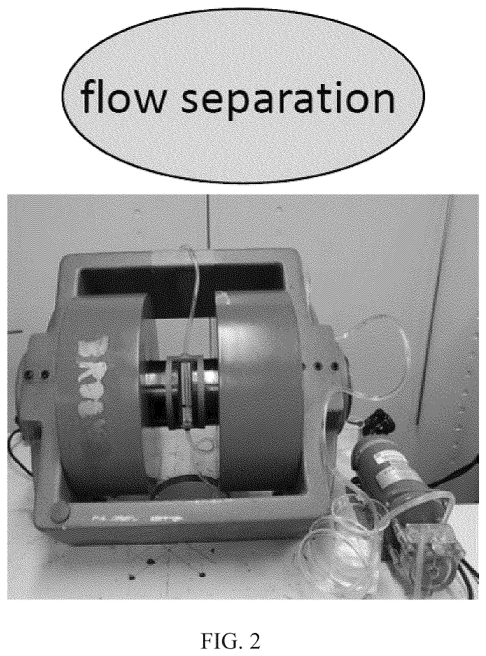

FIG. 2 shows an image of flow separation, according to an embodiment of the subject invention. Referring to FIG. 2, in the flow through process, first rare-earth metal ions and second rare-earth metal ions (different from the first rare-earth metal ions) can be sent through a mesh (e.g., a steel mesh, such as a magnetic (or ferromagnetic) stainless steel mesh) using a uniform magnetic field provided by a magnetic field source (e.g., an electromagnet). The ions can be in a solution. The mesh can have high magnetic permeability (e.g., a magnetic permeability of at least 1, at least 2, at least 3, at least 4, at least 5, at least 6, at least 7, at least 8, at least 9, at least 10, or higher). The uniform magnetic field can have a value in a range of, for example, from 0.1 Tesla (T) to 20 T (or any subrange, any value, or about any value therein, such as 1 T or about 1 T), though embodiments are not limited thereto. A higher proportion of the first ions can be captured by the mesh compared to the proportion of the second ions captured by the mesh. In some embodiments, there may be zero capture (or near zero capture, such as less than 0.1% capture by weight or by volume) of the second ions, indicating excellent separation of the first ions from the second ions. In certain embodiments, the second ions can be diamagnetic while the first ions are not diamagnetic (e.g., the first ions can be paramagnetic). The flow through separation process can be performed for an amount of time in a range of, for example, from 1 minute to 10 days (or any subrange, any value, or about any value therein, such as about 2 hours or about 16 hours), though embodiments are not limited thereto.

The related art does not include use of high magnetic field gradients of a mesh to separate rare-earth metal ions from each other. Existing separation techniques for magnetic particles focus on separating microparticles that are superparamagnetic (e.g., iron oxide). Embodiments of the subject invention can capture rare-earth metal ions that are paramagnetic (e.g., Dy⁺³), which are much smaller than nanoparticles (e.g., by two orders of magnitude) and are weakly magnetic compared to superparamagnetic particles. This can be done by, for example, using a magnetic 15 source (e.g., an electromagnet) to provide a uniform magnetic field, along with a mesh with high magnetic permeability to capture rare-earth ions that are paramagnetic.

Embodiments of the subject invention can be used to separate paramagnetic rare-earth metal ions (e.g., 30% or more by volume or by mass) from diamagnetic rare-earth metal ions in a solution that has both types of ions (e.g., equimolar concentration of these ions, though this is not necessary) in a short amount of time (e.g., 16 hours or less, such as about 16 hours, about 4 hours, or about 2 hours).

Embodiments of the subject invention are environmentally friendly compared to solvent-solvent extraction or ion-exchange methods, which produce a large amount of organic solvent that further leads to environmental pollution. Embodiments of the subject invention also have a very high separation efficiency compared to ion-exchange and solvent-solvent extraction methods that require thousands of thousands of re-runs that are slow to separate ions from each other. Embodiments of the subject invention are also less energy intensive and can be scaled up very easily compared to related art techniques such as solvent-solvent extraction and ion-exchange methods. Overall, embodiments of the subject invention can easily and efficiently separate rare-earth metal ions. Systems and methods of embodiments of the subject invention can also be used to separate and/or other materials, such as those used in cathodes of lithium ion batteries (e.g., nickel (Ni), cobalt (Co), lithium (Li), and/or manganese (Mn)). Related art methods for recycling and/or reusing these materials are chemical-based, slow, and energy intensive.

When ranges are used herein, combinations and subcombinations of ranges (e.g., any subrange within the disclosed range) and specific embodiments therein are intended to be explicitly included. When the term “about” is used herein, in conjunction with a numerical value, it is understood that the value can be in a range of 95% of the value to 105% of the value, i.e. the value can be +/−5% of the stated value. For example, “about 1 kg” means from 0.95 kg to 1.05 kg.

A greater understanding of the embodiments of the subject invention and of their many advantages may be had from the following examples, given by way of illustration. The following examples are illustrative of some of the methods, applications, embodiments, and variants of the present invention. They are, of course, not to be considered as limiting the invention. Numerous changes and modifications can be made with respect to embodiments of the invention.

### Example 1

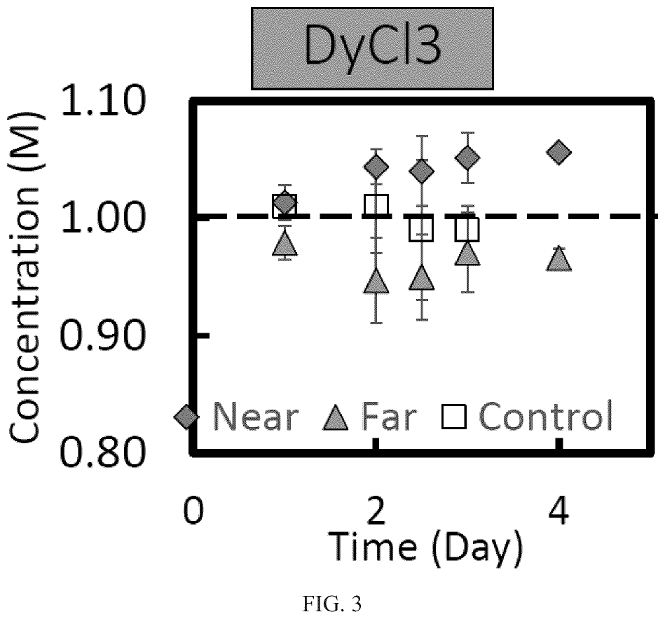

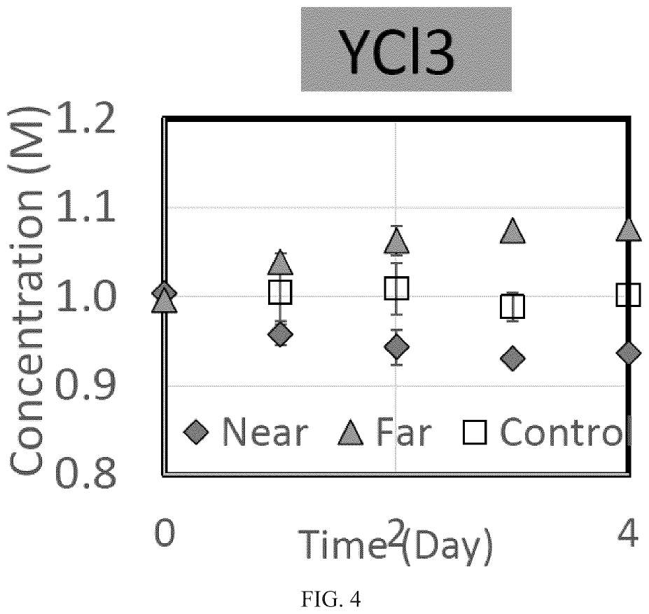

A batch process was performed to separate dysprosium (Dy⁺³) and yttrium (Y⁺³) ions from each other, as shown in FIG. 1. A solution including dysprosium (Dy⁺³) chloride (DyCl₃) and yttrium (Y⁺³) chloride (YCl₃) was provided in a porous medium, and a permanent magnet was used to apply a non-uniform magnetic field with a value of magnetic field times gradient of the magnetic field (i.e., B*(gradient(B))) of about 7 T²/m for about 2 days. The results are shown in FIGS. 3 and 4 and indicate that the paramagnetic Dy⁺³ ions moved toward the permanent magnet (“Near”) where the larger magnetic field gradient was imposed, while the diamagnetic Y⁺³ ions moved away from the permanent magnet. The Dy⁺³ showed a 10% concentration enhancement towards the non-uniform magnetic field with the value of B*(gradient(B)) of about 7 T²/m over a span of about 2 days, and the Y⁺³ ions showed a 10% concentration depletion towards (or 10% concentration enhancement away from) the same magnetic field profile over the course of about 2 days.

### Example 2

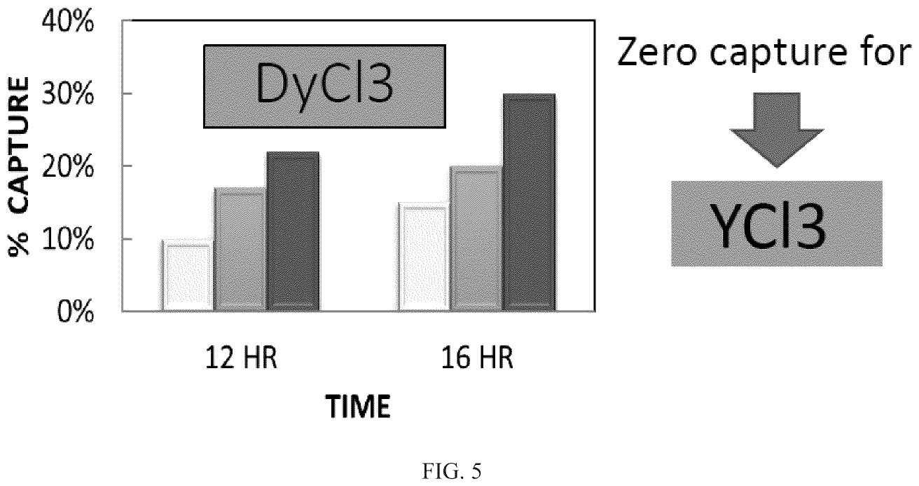

A flow through process was performed to separate dysprosium (Dy⁺³) and yttrium (Y⁺³) ions from each other, as shown in FIG. 2. A solution including DyCl₃ and YCl₃ was sent through a uniform magnetic field of about 1 T using a ferromagnetic stainless steel mesh for capture. The results are shown in FIG. 5 and indicate that about 30% of the Dy⁺³ were captured by the mesh after about 12 hours, while the Y⁺³ ions did not interact with the mesh over the same span of time (i.e., zero capture). Thus, this process can be used to separate Dy⁺³ from Y⁺³ very efficiently (e.g., even more efficiently than the batch process used in Example 1).

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein are incorporated by reference in their entirety, including all figures and tables, to the extent they are not inconsistent with the explicit teachings of this specification.

What is claimed is:

1. A method for magnetically assisted separation of metal ions, the method comprising:
generating a uniform magnetic field with a magnetic field source;
placing a solution in the uniform magnetic field, wherein the solution comprises first metal ions and second metal ions different from the first metal ions;
placing a mesh in or adjacent to the solution; and
allowing at least a portion of the first metal ions to be collected by the mesh while the second metal ions are not collected by the mesh.

2. The method according to claim 1, wherein the first metal ions are rare-earth metal ions and the second metal ions are rare-earth metal ions.

3. The method according to claim 1, wherein the first metal ions are paramagnetic, and
wherein the second metal ions are diamagnetic.

4. The method according to claim 1, wherein the first metal ions are dysprosium (Dy) ions, and
wherein the second metal ions are yttrium (Y) ions.

5. The method according to claim 1, wherein the mesh is magnetic stainless steel.

6. The method according to claim 1, wherein the solution is provided in the uniform magnetic field continuously for a period of time that is at least one minute.

7. The method according to claim 6, wherein the period of time is at least 16 hours.

8. The method according to claim 1, wherein the uniform magnetic field has a value in a range of from 0.1 Tesla (T) to 20 T.

9. The method according to claim 1, wherein the magnetic field source is an electromagnet.

10. A system for magnetically assisted separation of metal ions, the system comprising:
a magnetic field source generating a uniform magnetic field; and
a ferromagnetic mesh disposed within or adjacent to the uniform magnetic field,
wherein the system is configured to receive within the uniform magnetic field a solution comprising first metal ions and second metal ions different from the first metal ions and allow at least a portion of the first metal ions to be collected by the mesh while the second metal ions are not collected by the mesh.

11. The system according to claim 10, wherein the first metal ions are rare-earth metal ions and the second metal ions are rare-earth metal ions,
wherein the first metal ions are paramagnetic,
wherein the second metal ions are diamagnetic, and
wherein the magnetic field source is an electromagnet.

12. A method for magnetically assisted separation of metal ions, the method comprising:
generating a non-uniform magnetic field with a magnetic field source;
providing to the non-uniform magnetic field a porous medium comprising first metal ions and second metal ions different from the first metal ions; and
allowing at least a portion of the first metal ions to move through the porous medium towards the magnetic field source while at least a portion of the second metal ions move through the porous medium away from the magnetic field source.

13. The method according to claim 12, wherein the first metal ions are rare-earth metal ions and the second metal ions are rare-earth metal ions.

14. The method according to claim 12, wherein the first metal ions are paramagnetic, and
wherein the second metal ions are diamagnetic.

15. The method according to claim 12, wherein the first metal ions are dysprosium (Dy) ions, and
wherein the second metal ions are yttrium (Y) ions.

16. The method according to claim 12, wherein the first metal ions and the second metal ions are provided in a solution.

17. The method according to claim 12, wherein the non-uniform magnetic field has a value of magnetic field times gradient of the magnetic field (B*gradient(B)) in a range of from 1 square Tesla per meter (T²/m) to 20 T²/m,
wherein the first metal ions have a concentration enhancement of at least 10%, and
wherein the second metal ions have a concentration enhancement of at least 10.

18. The method according to claim 12, wherein the method is a batch process performed for a period of time that is in a range of from 1 hour to 10 days.

19. A system for magnetically assisted separation of metal ions, the system comprising:
a magnetic field source generating a non-uniform magnetic field; and
a porous medium disposed within the non-uniform magnetic field,
wherein the system is configured to perform the method according to claim 12.

20. The system according to claim 19, wherein the first metal ions are rare-earth metal ions and the second metal ions are rare-earth metal ions,
wherein the first metal ions are paramagnetic, and
wherein the second metal ions are diamagnetic.
